(19) United States
(12) Patent Application Publication
(10) Pub. No.: US 2022/0237289 A1
(43) Pub. Date: Jul. 28, 2022

(54) AUTOMATED MALWARE CLASSIFICATION WITH HUMAN-READABLE EXPLANATIONS

(71) Applicant: Avast Software s.r.o., Prague 4 (CZ)

(72) Inventors: Tomas Pevny, Prague 4 (CZ); Viliam Lisy, Svaty Jur (SK); Branislav Bosansky, Banska Bystrica (SK); Michal Pechoucek, Prague 6 (CZ); Vaclav Smidl, Dysina (CZ); Petr Somol, Marianske Lazne (CZ); Jakub Kroustek, Rajhrad (CZ); Fabrizio Biondi, Praha 2 (CZ)

(73) Assignee: Avast Software s.r.o., Prague 4 (CZ)

(21) Appl. No.: 17/159,909

(22) Filed: Jan. 27, 2021

(51) Int. Cl. G06F 21/56; G06F 21/53; G06N 3/08; G06N 3/04

(52) U.S. Cl. CPC G06F 21/562; G06F 21/53; G06F 2221/033; G06N 3/04; G06N 3/08

(57) ABSTRACT

A malware classification is generated for an input data set with a human-readable explanation of the classification. An input data set having a hierarchical structure is received in a neural network that has an architecture based on a schema determined from a plurality of second input data sets and that is trained to classify received input data sets into one or more of a plurality of classes. An explanation is provided with the output of the neural network, the explanation comprising a subset of at least one input data set that caused the at least one input data set to be classified into a certain class using the schema of the generated neural network. The explanation may further be derived from the statistical contribution of one or more features of the input data set that caused the at least one input data set to be classified into a certain class.

### FIELD

The invention relates generally to security in computerized systems, and more specifically to data-driven automated malware classification with human-readable explanations.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malware detection programs are designed to detect remailers, keystroke loggers, and other software that is designed to perform undesired operations such as stealing information from a computer or using the computer for unintended purposes. Similarly, web site scanning tools are used to verify the security and integrity of a website, and to identify and fix potential vulnerabilities.

For example, antivirus software installed on a personal computer or in a firewall may use characteristics of known malicious data to look for other potentially malicious data, and block it. In a personal computer, the user is typically notified of the potential threat, and given the option to delete the file or allow the file to be accessed normally. A firewall similarly inspects network traffic that passes through it, permitting passage of desirable network traffic while blocking undesired network traffic based on a set of rules. Tools such as these rely upon having an accurate and robust ability to detect potential threats, minimizing the number of false positive detections that interrupt normal computer operation while catching substantially all malware that poses a threat to computers and the data they handle. Accurately identifying and classifying new threats is therefore an important part of antimalware systems, and a subject of much research and effort.

But, determining whether a new file is malicious or benign can be difficult and time-consuming, even when human researchers are simply confirming a machine-based determination. It is therefore desirable to provide machine-based malware determinations and classifications that reduce the workload on human malware researchers.

### SUMMARY

One example embodiment of the invention comprises a method of generating a malware classification for an input data set with a human-readable explanation, where the data set comprises a group of data. An input data set having an hierarchical structure is received in a neural network that has an architecture based on a schema determined from a plurality of second input data sets and that is trained to classify received input strings into one or more of a plurality of classes. An explanation is provided with the output of the neural network, the explanation comprising a subset of at least one input data set that caused the at least one input data set to be classified into a certain class using the schema of the generated neural network.

In a further example, the explanation comprises one or more logical rules that cause the subset of the input data set to produce the output malware classification when processed in the neural network. In another example, the explanation is derived from the statistical contribution of one or more features of the input data set that caused the at least one input data set to be classified into a certain class.

The details of one or more examples of the invention are set forth in the accompanying drawings and the description below. Other features and advantages will be apparent from the description and drawings, and from the claims.

### BRIEF DESCRIPTION OF THE FIGURES

FIG. 1 shows an example malware classification system, consistent with an example embodiment.

FIG. 2 shows an example of a malware classification neural network automatically constructed from the schema of a hierarchical input file, consistent with an example embodiment.

FIG. 3 is a flowchart of a method of generating a malware classification for an input data set with a human-readable explanation, consistent with an example embodiment of the invention.

FIG. 4 is a computerized malware characterization system, consistent with an example embodiment of the invention.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to computers to steal, delete, or change information, or to encrypt the information and hold it for ransom via “ransomware.” Smartphone apps, Microsoft® Word documents containing macros, Java™ applets, and other such common files are all frequently infected with malware of various types, and users rely on tools such as antivirus software or other malware protection tools to protect their computerized devices from harm.

In a typical home computer or corporate environment, firewalls inspect and restrict the types of communication that can occur between local devices such as computers or IoT devices and the Internet, antivirus programs prevent known malicious files from being loaded or executed on a computer system, and malware detection programs detect known malicious code such as remailers, keystroke loggers, and other software that is designed to perform undesired operations such as stealing information from a computer or using the computer for unintended purposes. But, with new threats constantly emerging, efficient and timely detection and classification of vulnerabilities within computerized systems and IoT devices such as a home appliance remain a significant challenge. New anti-malware algorithms, artificial intelligence networks or systems, and other such solutions are therefore constantly under development.

Machine learning tools such as neural networks are often used to analyze and classify potential new threats, with varying degrees of success. Some machine learning or artificial intelligence models such as Bayesian networks use decision trees and probabilities or statistics to make determinations. Other more sophisticated systems use neural networks designed to mimic human brain function. Some neural networks, such as recurrent or convolutional neural networks, can have what is termed a “Long Short Term Memory,” (LSTM), or the ability to have some persistence of memory such that events that happened long ago continue to influence the output of the system. As these systems become increasingly complex, the ability of a human observer to understand the function of the artificial intelligence system or the factors that contributed to the system's output is diminished, as the coefficients of a neural network are difficult to understand and the coefficients of an LSTM network are even more complex.

Because it is difficult to understand the process by which many artificial intelligence or machine learning systems generate their output, there is often a lack of human confidence in the accuracy or certainty of the output (sometimes called the “Black Box Verdict” problem). In many examples, even the inputs to a neural network are vectorized and not human-readable, and the interaction between many different types of sparse inputs are not easy to intuitively understand. Further, the large amount of data available as inputs, such as sandbox or other behavioral logs, reputation databases, and a variety of format-specific or subtype-specific data, can mask the importance of various factors in reaching a conclusion regarding classification of potentially malicious data.

Some examples presented herein therefore provide a data-driven automated malware classification system with human-readable explanations. In a more detailed example, malware classification based on input data such as a file's hierarchical characteristics are processed and a decision regarding malware classification is produced, and a human-readable explanation of the basis or the factors contributing significantly to the malware classification are also provided in human-readable form.

In a more detailed example, a malware classification system receives a set of input data in a hierarchical form, such as observed characteristics of files to be analyzed when executed in a sandbox environment or the like. The hierarchical form is in some examples JavaScript Object Notation (JSON) data, Extensible Markup Language (XML) data, or another suitable hierarchical data format. A schema of the received input data is determined from the set of hierarchical input data, and is used to construct an artificial intelligence engine such as a hierarchical multiple-instance-learning neural network. The generated neural network is trained on a set of input data sets with known malware classifications so that the trained network is operable to classify the received input data sets into one or more of a plurality of malware classes. An explanation generation module uses the schema of the generated neural network and the hierarchy of the input data sets to provide an explanation as to what caused at least one of the input data sets to be classified into a certain malware class, the explanation including a subset of the input data set that is most responsible or most relevant in generating the data's classification.

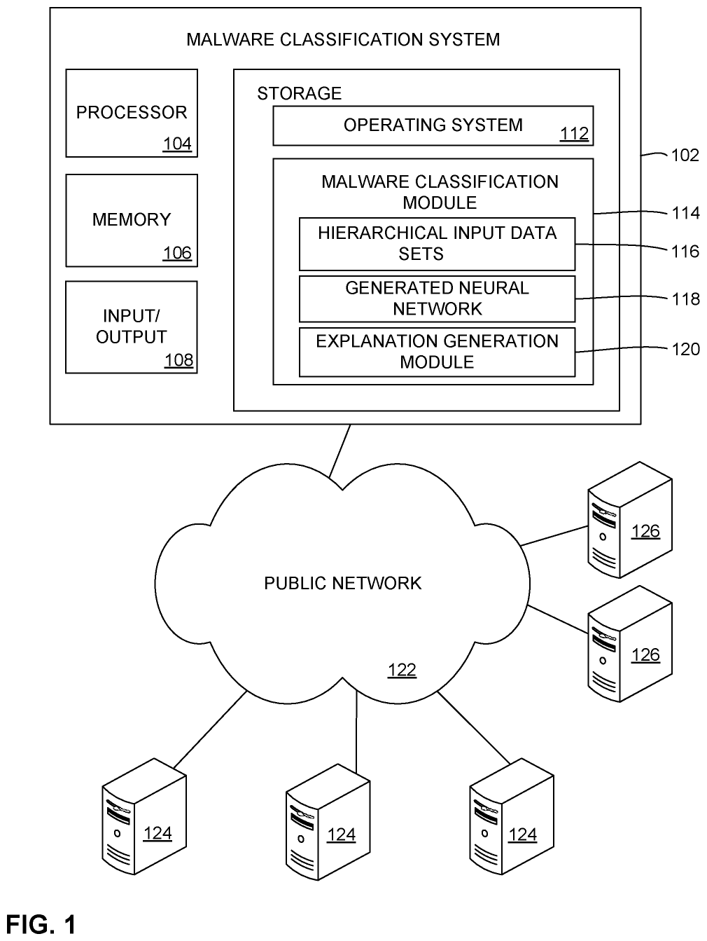

FIG. 1 shows an example malware classification system, consistent with an example embodiment. Here, a network device such as malware classification system 102 comprises a processor 104, memory 106, input/output elements 108, and storage 110. Storage 110 includes an operating system 112, and a malware classification module 114 that is operable to provide a malware classification of files along with an explanation as to why a file was classified in a certain way. The malware classification module 114 includes in this example a set of hierarchical input data sets 116, such as may be used to construct and train the generated neural network 118 or as may be provided as input for classification as to the presence and/or type of malware present in the data set. The hierarchical input data sets 116 in a further example comprise data encoded in human-readable form, such as JavaScript Object Notation (JSON) data, Extensible Markup Language (XML) data, or another suitable hierarchical data format, which use human-readable words and a structural relationship or organization of data.

The generated neural network 118 in some examples is constructed at least in part based on the hierarchical structure found in one or more of the hierarchical input data sets 116, such that the inputs to the generated neural network 118 are not the typical vectorized inputs commonly used in anti-malware neural networks but are instead based on the hierarchy of human-readable data in the data sets 116. The generated neural network 116 is trained using traditional methods to generate an output that classifies input data sets as malware and/or as a type of malware, a part of a family of malware, or with another such malware classification. After training, the generated neural network 118 is operable to receive a hierarchical input data set of unknown type and provide a malware classification, and explanation generation module 120 is operable to provide an explanation as to why the data was classified in a certain way such as by providing a subset of the input data set that is determined most responsible or statistically deterministic in the data's classification. This is achieved in part due to the configuration of the generated neural network 118, which is constructed such that the hierarchical data sets provided as input are used to architect the neural network and are provided as inputs to the neural network, and so can be evaluated as to their contribution to the neural network's output or malware classification of the input data set.

The malware classification system 102 in this example is coupled to a network, such as public network 122, enabling the malware classification system to communicate with other computers such as sandbox or other test computers 124 used to observe potential malware and to construct the hierarchical input data sets 116, and malware analyst computers 126 used by malware analysts to research new files and assign them a malware classification. In a more detailed example, a file newly identified on public network 122 but not yet classified is captured for evaluation and classification. As part of this process, certain characteristics of the executable code in the file are analyzed, and the code's behavior when executing in an isolated or sandboxed computer 124 are observed by a malware analyst 126. Characteristics of the new file are encoded in a hierarchical file such as a JSON or XML, file provided to the malware classification system 102 as a hierarchical input data set, which is processed in the generated neural network 118 and explanation generation module 120 to classify the new file and provide an explanation as to what elements of the hierarchical input data set resulted in the assigned classification.

The generated neural network 118 in some examples is a hierarchical multi-instance-learning based neural network, which is a neural network architecture configured to work with hierarchies of sets of data. In other examples, probabilistic decision trees or other such models can be used to achieve similar results. The hierarchical data provided as inputs includes in various examples sandbox behavioral characteristics such as logs generated when executing code in a file of interest in a sandbox environment, characteristics of an executable file's structure or anticipated behavior such as accessing certain hardware or certain operating system functions, and the like. This information is provided via hierarchical values as an input data set to the generated neural network in key-value pairs that are sometimes called features, and which determine the classification of the file of interest.

The features or key-value pairs contributing most strongly to the classification assigned to the file of interest can be determined in one example by assigning a quality or influence score to key-feature pairs in the hierarchical input data set. This is done such as by adding features such as sequentially or in random order and observing the output of the generated neural network to determine the influence of different key-value pairs on the output, such that features having a strong influence on the malware classification generated by the neural network can be identified as an explanation for the malware classification. The explanation in further examples is reduced to rules or feature subsets that produce a more compact explanation, taking advantage of the underlying structure of the hierarchy of the data and of the generated neural network. This is desirable in many instances so that the malware analysts 126 can more easily understand the explanation.

In one such example, parent-child relationships in the hierarchy of data are considered, such as where different child features contribute to classification in a similar way and can be better characterized by including a parent feature in the explanation. Once a parent feature is selected for inclusion in the explanation, child features (and especially child features having similar contributions to classification of the input data set) no longer need to be considered individually for inclusion in the explanation generated at 120. Similarly, single samples of data that behave similarly to similar samples, such as observing similar behaviors when executing in a sandbox or other cases where a hierarchical feature is similar to other hierarchical features, can often be grouped if there is a hierarchical relationship between the features. This again provides for more compact and readable explanations.

Explanations in some examples are provided as exhaustive, including each input element found to make a statistical contribution to the output malware classification, but in other examples are reduced or minimized. In one such example, methods such as bound-and-branch are used to provide a relatively small explanation feature set having a high degree of influence on the malware classification. Modifications to branch-and-bound, such as a fast branch-and-bound algorithm or a branch-and-bound algorithm modified to evaluate or provide smaller explanations first may produce a more compact and more easily understandable output.

The explanation in some further examples is limited to a certain class, such as with respect to only a specific classification of malware being evaluated, such as to determine whether a file is or is not ransomware, while in other examples will span multiple classes such as to indicate that a piece of malware has characteristics of both a botnet and a cryptominer. Explanations may be provided as a set of logical rules, such as utilizing AND, OR, and NOT operators to explain the logical relationship between input features from the hierarchical input data set and the output malware classification. In one such example, several features in certain combinations having certain logical relationships to one another may be required to reach a malware classification, and logical rules can be used to present these features to the end user as part of the explanation.

The example generated neural network in the example of FIG. 1 is a hierarchical multi-instance-learning based neural network which is not architected to consider order of features as a factor in determining an output. In an alternate example, the generated neural network 118 will be sensitive to the order of input features, enabling more precise classification of malware at the expense of computational efficiency. For example, a hierarchical multi-instance learning based neural network may be able to identify a snippet of JavaScript code as containing certain features, but a sequence or order-sensitive neural network will additionally be able to identify the order of features in the JavaScript snippet and better recognize or predict its functionality. Ordering of features in such examples becomes more important in determining the output, and features that are not simply ordered executable code using methods such as a Shapley values, which are known in the data processing art. In other examples, a feature selection algorithm will preprocess features in other ways, such as by selecting certain features for processing while discarding others based on knowledge of the relevance of certain features to malware classification.

While methods such as these seek to improve the explanation by reducing the size, improving the readability, and ensuring a high degree of accuracy of the explanation, there are tradeoffs between providing a minimal explanation and a robust explanation. An explanation in some examples is therefore not minimized beyond a threshold of difference in degree of confidence in output or in malware classification. Similarly, if several explanations of a similar size are available, the explanation that yields the highest confidence is chosen or is ordered first in providing an explanation to an analyst. In other examples, thresholds for minimizing the explanation are employed, or other factors such as manual weighting of certain preferred features of interest may be used in selecting an explanation for output.

Assessing the quality of an explanation in making such determinations can be difficult, but can be estimated using methods such as observing human acceptance of the machine-based malware classification, or by using quantitative methods such as by generating a metric for comparing a set of explanatory rules with the statistical strength of the malware classification generated by the malware classification module 114. For example, if several analysts accept a machine-generated malware classification as correct after reviewing the classification, it is more likely to be correct. Similarly, if an explanation is more precise, results in fewer false positives, and misclassifies fewer input data sets, the explanation can be considered to have higher quality.

When a new file is classified as being potentially or likely malicious, a knowledge base regarding malicious and benign files is updated so that definitions can be created from which anti-malware tools can use the new knowledge to detect malicious files. By automatically providing a basic explanation of the classification of a new file, the malware analyst can more easily verify or challenge the malware classification module's determination. When more sophisticated explanations are provided, such as logic rules or the like, such rules may be readily adapted into rule sets already used for malware detection, streamlining the process of detecting new malware and protecting client computers from the newly-found threats.

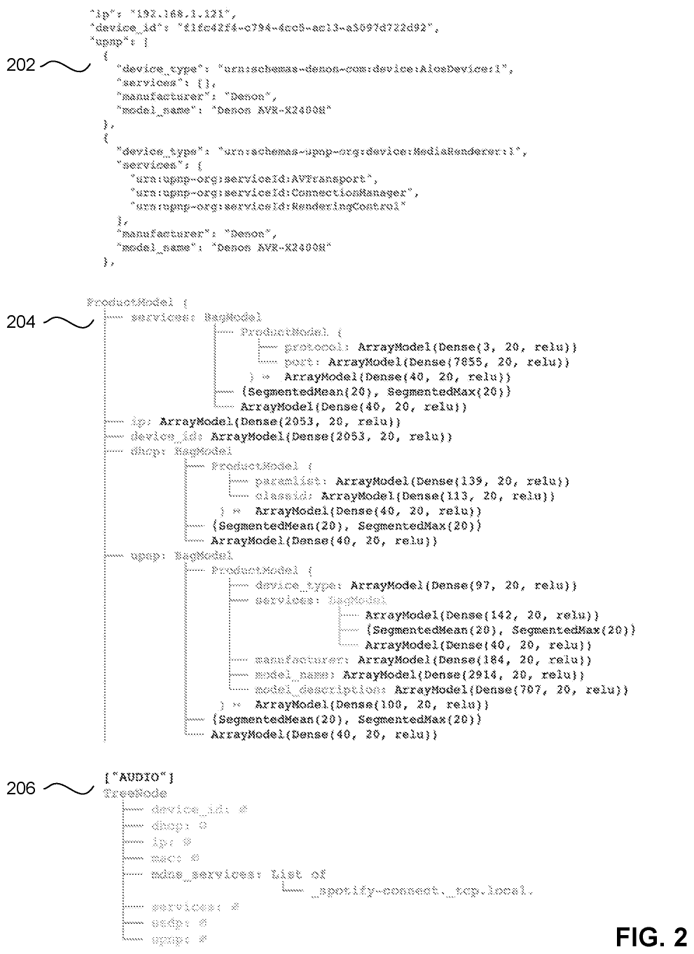

FIG. 2 shows an example of a malware classification neural network automatically constructed from the schema of a hierarchical input file, consistent with an example embodiment. In this simplified example, a device identification is determined from a hierarchical raw record about a single device as shown in the hierarchical data set at 202. The raw device data includes manufacturer and model information as part of a UPNP transaction, along with media rendering information provided as part of services published and visible at the device's IP address. From this hierarchical information, a neural network is autonomously constructed as shown at 204. The neural network structure is based on the input data, such that the hierarchy of the input data is reflected in the neural network's inputs, size, and configuration. A sample explanation as shown at 206 accompanies the output of a neural network as shown at 204 processing a hierarchical input data set as shown at 202, showing that the mdns_services raw record sufficed to classify the device as an audio device in this case.

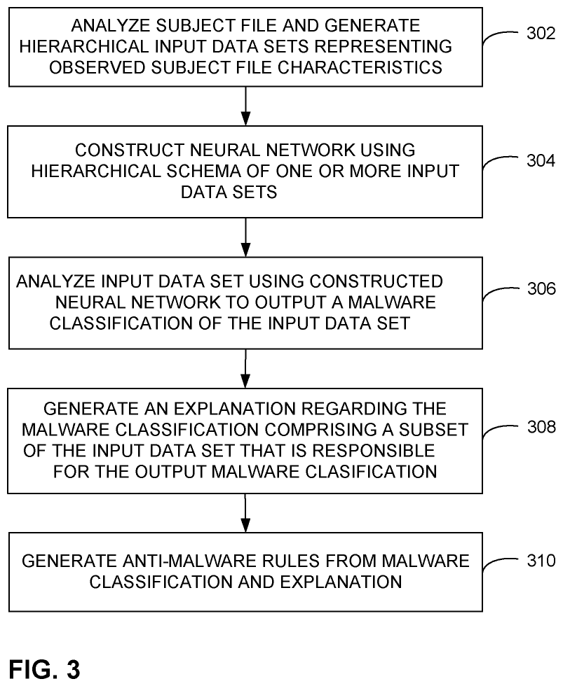

FIG. 3 is a flowchart of a method of generating a malware classification for an input data set with a human-readable explanation, consistent with an example embodiment of the invention. At 302, a subject file (or other subject such as a network device) to be identified or classified is analyzed, such as by observing its operation in a safe “sandbox” isolated environment, and the observed characteristics of the subject are stored in a hierarchical input data set (such as is shown at 202 of FIG. 2). One or more such hierarchical input data sets are used to construct a neural network at 304, such as by deriving the hierarchical schema from the data sets to build a neural network configured to receive hierarchical data in the schema as inputs.

The generated hierarchical input data set is processed in the trained neural network at 306, producing an output that comprises a malware classification. In various examples, the classification comprises a malware type, a malware family, a device type, or other such classification. An explanation of the input hierarchical element or elements and their respective values that contributed most strongly to the malware classification determination is generated at 308, such as by analyzing the classification of different subsets of the hierarchical input data set to determine which input elements are most responsible for the input data's malware classification. In a further example, the explanation is processed or is chosen from multiple explanations to achieve certain goals, such as minimal size, high degree of effectiveness, or expression as logic rules. The explanation can then be reviewed by a human analyst and verified or approved, and used at 310 to generate anti-malware rules that can be used in anti-malware software to protect client computers.

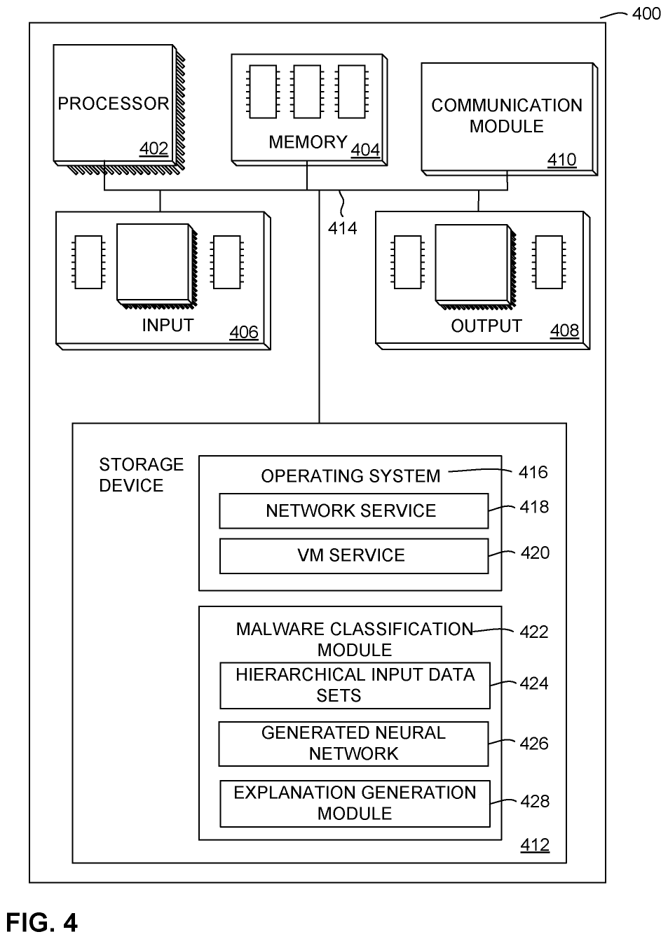

The examples presented herein show how the process of classifying new files as malware can be effectively automated in a way that provides a human-readable explanation for the classification, reducing the burden on human analysts to review machine-based classifications for accuracy and reliability. In some example embodiments, the systems, methods, and techniques described herein are performed on one or more computerized systems. Such computerized systems are able in various examples to perform the recited functions such as collecting file data, deriving a hierarchical input data from the file data, analyzing generating a neural network corresponding to the input data hierarchy, providing an explanation of the input factors that cause an input data set to be classified in a certain way, and other such tasks by executing software instructions on a processor, and through use of associated hardware. FIG. 4 is one example of such a computerized malware characterization system. FIG. 4 illustrates only one particular example of computing device 400, and other computing devices 400 may be used in other embodiments. Although computing device 400 is shown as a standalone computing device, computing device 400 may be any component or system that includes one or more processors or another suitable computing environment for executing software instructions in other examples, and need not include all of the elements shown here.

As shown in the specific example of FIG. 4, computing device 400 includes one or more processors 402, memory 404, one or more input devices 406, one or more output devices 408, one or more communication modules 410, and one or more storage devices 412. Computing device 400 in one example further includes an operating system 416 executable by computing device 400. The operating system includes in various examples services such as a network service 418 and a virtual machine service 420 such as a virtual server or virtualized honeypot device. One or more applications, such as malware classification module 422 are also stored on storage device 412, and are executable by computing device 400.

Each of components 402, 404, 406, 408, 410, and 412 may be interconnected (physically, communicatively, and/or operatively) for inter-component communications, such as via one or more communications channels 414. In some examples, communication channels 414 include a system bus, network connection, inter-processor communication network, or any other channel for communicating data. Applications such as malware classification module 422 and operating system 416 may also communicate information with one another as well as with other components in computing device 400.

Processors 402, in one example, are configured to implement functionality and/or process instructions for execution within computing device 400. For example, processors 402 may be capable of processing instructions stored in storage device 412 or memory 404. Examples of processors 402 include any one or more of a microprocessor, a controller, a digital signal processor (DSP), an application specific integrated circuit (ASIC), a field-programmable gate array (FPGA), or similar discrete or integrated logic circuitry.

One or more storage devices 412 may be configured to store information within computing device 400 during operation. Storage device 412, in some examples, is known as a computer-readable storage medium. In some examples, storage device 412 comprises temporary memory, meaning that a primary purpose of storage device 412 is not long-term storage. Storage device 412 in some examples is a volatile memory, meaning that storage device 412 does not maintain stored contents when computing device 400 is turned off. In other examples, data is loaded from storage device 412 into memory 404 during operation. Examples of volatile memories include random access memories (RAM), dynamic random access memories (DRAM), static random access memories (SRAM), and other forms of volatile memories known in the art. In some examples, storage device 412 is used to store program instructions for execution by processors 402. Storage device 412 and memory 404, in various examples, are used by software or applications running on computing device 400 such as malware classification module 422 to temporarily store information during program execution.

Storage device 412, in some examples, includes one or more computer-readable storage media that may be configured to store larger amounts of information than volatile memory. Storage device 412 may further be configured for long-term storage of information. In some examples, storage devices 412 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 400, in some examples, also includes one or more communication modules 410. Computing device 400 in one example uses communication module 410 to communicate with external devices via one or more networks, such as one or more wireless networks. Communication module 410 may be a network interface card, such as an Ethernet card, an optical transceiver, a radio frequency transceiver, or any other type of device that can send and/or receive information. Other examples of such network interfaces include Bluetooth, 4G, LIE, or 5G, WiFi radios, and Near-Field Communications (NFC), and Universal Serial Bus (USB). In some examples, computing device 400 uses communication module 410 to wirelessly communicate with an external device such as via public network 122 of FIG. 1.

Computing device 400 also includes in one example one or more input devices 406. Input device 406, in some examples, is configured to receive input from a user through tactile, audio, or video input. Examples of input device 406 include a touchscreen display, a mouse, a keyboard, a voice-responsive system, a video camera, a microphone, or any other type of device for detecting input from a user.

One or more output devices 408 may also be included in computing device 400. Output device 408, in some examples, is configured to provide output to a user using tactile, audio, or video stimuli. Output device 408, in one example, includes a display, a sound card, a video graphics adapter card, or any other type of device for converting a signal into an appropriate form understandable to humans or machines. Additional examples of output device 408 include a speaker, a light-emitting diode (LED) display, a liquidcrystal display (LCD), or any other type of device that can generate output to a user.

Computing device 400 may include operating system 416. Operating system 416, in some examples, controls the operation of components of computing device 400, and provides an interface from various applications such as malware classification module 422 to components of computing device 400. For example, operating system 416, in one example, facilitates the communication of various applications such as malware classification module 422 with processors 402, communication unit 410, storage device 412, input device 406, and output device 408. Applications such as malware classification module 422 may include program instructions and/or data that are executable by computing device 400. As one example, malware classification module 422 uses one or more hierarchical input data sets representing a file, device, or other subject for classification at 424 to generate a neural network 426 having a structure dependent on the hierarchy of the input data sets. An explanation generation module 428 provides a human-readable explanation for the classification, reducing the burden on human analysts to review machine-based classifications for accuracy and reliability. These and other program instructions or modules may include instructions that cause computing device 400 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of generating a malware classification for an input data set with a human-readable explanation, comprising:
receiving an input data set having a hierarchical structure;
analyzing the input data set using an artificial intelligence module to automatically output a malware classification for the received input data set; and
generating an explanation regarding the malware classification comprising a subset of the input data set that is responsible for the output malware classification.

2. The method of generating a malware classification for an input data set with a human-readable explanation of claim 1, further comprising constructing the artificial intelligence module using a hierarchy of the input data set.

3. The method of generating a malware classification for an input data set with a human-readable explanation of claim 1, wherein the artificial intelligence module is a neural network.

4. The method of generating a malware classification for an input data set with a human-readable explanation of claim 3, wherein the neural network comprises a hierarchical multiple-instance-learning neural network.

5. The method of generating a malware classification for an input data set with a human-readable explanation of claim 1, wherein the input data set having a hierarchical structure comprises JavaScript Object Notation (JSON) data or an Extensible Markup Language (XML) data.

6. The method of generating a malware classification for an input data set with a human-readable explanation of claim 1, wherein the input data set is derived from at least one of sandbox execution of a file, static Portable Executable (PE) file analysis, or disassembly of executable code.

7. The method of generating a malware classification for an input data set with a human-readable explanation of claim 1, wherein the malware classification comprises at least one of types of malware and families of malware.

8. The method of generating a malware classification for an input data set with a human-readable explanation of claim 1, wherein the explanation comprises one or more logical rules that cause the subset of the input data set to produce the output malware classification via the artificial intelligence module.

9. A method of generating a malware classification for an input data set with a human-readable explanation, comprising:
receiving a plurality of input data sets having a hierarchical structure;
determining a schema from one or more of the received input data sets;
generating a neural network architecture based on the determined schema;
training the generated neural network using the received plurality of input data sets to classify the received input data sets into one or more of a plurality of malware classes;
providing an explanation comprising a subset of at least one input data set that caused the at least one input data set to be classified into a certain malware class using the schema of the generated neural network.

10. The method of generating a malware classification for an input data set with a human-readable explanation of claim 9, wherein the input data set having a hierarchical structure comprises JavaScript Object Notation (JSON) data or an Extensible Markup Language (XML) data.

11. The method of generating a malware classification for an input data set with a human-readable explanation of claim 9, wherein the input data set is derived from at least one of sandbox execution of a file, static Portable Executable (PE) file analysis, or disassembly of executable code.

12. The method of generating a malware classification for an input data set with a human-readable explanation of claim 9, wherein the neural network comprises a hierarchical multiple-instance-learning neural network.

13. The method of generating a malware classification for an input data set with a human-readable explanation of claim 9, wherein the malware classification comprises at least one of types of malware and families of malware.

14. The method of generating a malware classification for an input data set with a human-readable explanation of claim 9, wherein the explanation comprises one or more logical rules that cause the subset of the input data set to produce the output malware classification via the artificial intelligence module.

15. A method of generating a malware classification for an input data set with a human-readable explanation, comprising:
receiving an input data sets having hierarchical structure;
processing the received input data set in a neural network, the neural network having an architecture based on a schema determined from a plurality of second input data sets and trained to classify received input data sets into one or more of a plurality of classes; and
providing an explanation comprising a subset of at least one input data set that caused the at least one input data set to be classified into a certain class using the schema of the generated neural network.

16. The method of generating a malware classification for an input data set with a human-readable explanation of claim 15, further comprising constructing the neural network constructed using a hierarchy of the input data set.

17. The method of generating a malware classification for an input data set with a human-readable explanation of claim 15, wherein the neural network comprises a hierarchical multiple-instance-learning neural network.

18. The method of generating a malware classification for an input data set with a human-readable explanation of claim 15, wherein the input data set is derived from at least one of sandbox execution of a file, static Portable Executable (PE) file analysis, or disassembly of executable code.

19. The method of generating a malware classification for an input data set with a human-readable explanation of claim 15, wherein the explanation comprises one or more logical rules that cause the subset of the input data set to produce the output malware classification via the neural network.

20. The method of generating a malware classification for an input data set with a human-readable explanation of claim 19, wherein the explanation is derived from the statistical contribution of one or more features of the input data set that caused the at least one input data set to be classified into a certain class.
